(19) United States
(12) Patent Application Publication
(10) Pub. No.: US 2025/0269726 A1
(43) Pub. Date: Aug. 28, 2025

(54) Electrical Circuit, On-Board Power Supply System, Vehicle, Method, Computer Program, And Computer-Readable Medium

(71) Applicant: Schaeffler Technologies AG & Co. KG, Herzogenaurach (DE)

(72) Inventor: Ayman Ayad, Regensburg (DE)

(73) Assignee: Schaeffler Technologies AG & Co. KG, Herzogenaurach (DE)

(21) Appl. No.: 19/064,269

(22) Filed: Feb. 26, 2025

(30) Foreign Application Priority Data
Feb. 27, 2024 (DE) 10 2024 201 774.4

(51) Int. Cl. B60L 3/00; B60L 53/24; B60L 55/00; H02J 3/00; H02J 3/32; H02J 7/02

(52) U.S. Cl. CPC B60L 3/0092; B60L 3/003; B60L 3/0061; B60L 53/24; B60L 55/00; H02J 3/0073; H02J 3/322; H02J 7/02; B60L 2210/10; B60L 2210/30; B60L 2210/40

(57) ABSTRACT

An electrical circuit for a vehicle is provides. The electric circuit includes a basic voltage converter which is designed to convert, in a redundancy operating mode, a direct current of a power storage unit into an alternating current for supplying power to an electric drive motor. An on-board power supply system, a vehicle, a method, a computer program, and a computer-readable medium are also provided.

### CROSS-REFERENCE TO RELATED APPLICATIONS

This application claims the benefit of German Patent Application 10 2024 201 774.4, filed Feb. 27, 2024. The disclosure of the above application is incorporated herein by reference.

### TECHNICAL FIELD

The disclosure relates to an electrical circuit having a basic voltage converter, to an on-board power supply system having the electrical circuit, to a vehicle having the electrical circuit or the on-board power supply system, to a method for operating the electrical circuit, the on-board power supply system or the vehicle, to a computer program, and to a computer-readable medium.

### BACKGROUND

DE 10 2016 213 070 B4 relates to a vehicle on-board power supply system having a voltage converter for driving an electric machine.

The disadvantage of the devices in the prior art is that in the event of a fault in the voltage converter or in the electric machine, the vehicle equipped with the vehicle on-board power supply system is unfit to drive. In the worst case, this poses a risk to the vehicle occupants, which is why the requirements for operational safety are constantly increasing.

### SUMMARY

The disclosure provides a solution which is distinguished in particular in that the disadvantages of such devices from the prior art are overcome. A further problem includes providing an alternative to the prior art, which is distinguished in particular by its redundancy.

One aspect of the disclosure provides an electrical circuit for a vehicle. The electrical circuit includes a basic voltage converter which is designed to convert, in a charging mode, an alternating current from a power grid into a direct current for a power storage unit (in the sense of rectification). The basic voltage converter is designed to convert, in a redundancy operating mode, a direct current of the power storage unit and/or a direct current of a fuel cell and/or a current, such as direct current or alternating current, of a generator into an alternating current for supplying power to an electric drive motor (in the sense of inversion). Owing to these features, the basic voltage converter can be referred to as a bidirectional rectifier. The basic voltage converter may be in the form of a bidirectional rectifier.

As a result, the basic voltage converter may be used as a redundant or additional power supply to a or a further electric drive motor owing to the redundancy operating mode.

Implementations of the disclosure may include one or more of the following optional features. In some implementations, the fuel cell is used to charge the power storage unit.

In some examples, the fuel cell is in the form of a primary energy source of the vehicle. Alternatively, the fuel cell may be in the form of a further energy source, in addition to the power storage unit and/or the battery and/or the traction battery.

The generator may be designed to convert a movement, such as a drive rotation, into a current. The drive rotation may be provided by a combustion engine of a range extender. For this purpose, for example, a belt drive or a chain drive or a direct drive for transferring the drive rotation to the generator is conceivable. Moreover, the generator and/or the range extender and/or combustion engine may be designed to charge the power storage unit, as needed. The generator may be, for example, regulated, alternating current generator. The regulation may pertain to the present power requirement.

The current of the generator, i.e., the current provided by the generator, may be an alternating current or a direct current. For example, it is a direct current if the generator already includes a rectifier. A commercially available inverter may be used because it already has an integrated rectifier.

Furthermore, the electrical circuit may be designed to switch between the following power sources as needed in order to provide the current of the respective connected power source to the main voltage converter and/or, for example, if the respective current is not and/or cannot be provided to the main voltage converter, to the basic voltage converter: power storage unit and/or fuel cell and/or generator.

The electrical circuit may be designed in such a way that the switching is carried out as needed depending on a fault on one of the voltage converters and/or an electric drive motor and/or one of the energy sources, for example, in such a way that an energy supply to an electric drive motor or the electric drive motor is always guaranteed.

The electrical circuit, for example the main voltage converter and the basic voltage converter are able to be switched between the modes mentioned above and below. The switching between the modes or the operation of modes in parallel with one another is preferably able to be controlled by way of a control device. For this purpose, the control device uses sensors and monitoring devices to decide when which mode is operated.

In some examples, the power storage unit is a rechargeable battery which may be in the form of a traction battery, for a vehicle. The power storage unit may have a voltage of at least 200 volts, 400 volts, 600 volts or 800 volts. In some examples, the battery includes a plurality of battery cells. In addition, it is conceivable for the electrical circuit to include a battery management system which monitors the electrical voltage of the individual battery cells, such as during a charging process during the charging mode. For example, the charging mode can be initialized or terminated by the battery management system depending on the state of charge or the voltage of the battery or the battery cells, such as by the control device. Overcharging of the battery cells, which could lead to damage to the battery cells, can thus be avoided. Too deep a discharge, which could damage the battery, can also be avoided during the redundancy operating mode or an operating mode which is discussed below, thus extending the life of the batteries. In the charging mode, the power storage unit is charged or able to be charged.

Basically, if a power grid is mentioned several times, the same power grid or another power grid, that is to say a further power grid, is meant thereby. Basically, if a drive motor is mentioned several times, the same drive motor or another drive motor, that is to say a further drive motor, is meant thereby. Basically, if a direct or alternating current is mentioned several times, the same direct or alternating current or another direct or alternating current, that is to say a further direct or alternating current, is meant thereby. The drive motor is an electric motor. The power grid is a public AC grid (single-or multi-phase). To avoid undesirable repercussions, the basic voltage converter is equipped with the function of a power factor correction (PFC) filter. For example, the basic voltage converter is in the form of a bidirectional power factor correction filter, i.e., is able (in the charging mode) to rectify while controlling/reducing the power factor which arises for the alternating voltage side of the power factor correction filter, in order to thus avoid undesirable repercussions for the power grid, and is furthermore able (in the redundancy operating mode) to convert a direct voltage by way of inversion into an alternating current suitable for supplying power to an electric drive motor.

In some implementations, the electric drive motor is a permanently excited or separately excited synchronous machine or an asynchronous machine. The electric drive motors may be traction motors which are operated, that is to say driven or able to be driven, with alternating current. The drive motor may be in the form of an alternating current machine (asynchronous motor or synchronous motor). The drive motor is configured to form a rotating magnetic field when supplied with an alternating current (three-phase current). This can be followed by the rotor of the drive motor.

In some examples, the power grid is a stationary and/or external power grid, such as, a public power grid, for instance a public AC grid.

In some implementations, the electrical circuit includes a main voltage converter which is designed to convert, in an operating mode, a direct current of the power storage unit and/or a direct current of the fuel cell and/or a current of the generator into an alternating current for supplying power to an electric drive motor. Owing to this feature, the main voltage converter can also be referred to as an inverter. The main voltage converter may be in the form of an inverter.

In some implementations, the main voltage converter in the operating mode has a higher efficiency than the basic voltage converter in the redundancy operating mode. The efficiency comparison here relates to the conversion of direct current of the power storage unit into alternating current for an electric drive motor, such as starting from the same DC voltage level to a comparable alternating current. As a result, the basic voltage converter can have a more cost-effective design than if the basic voltage converter during the redundancy operating mode had the same efficiency as the main voltage converter during the operating mode. Furthermore, the main voltage converter may be able to convert a higher electrical power during the operating mode than the basic voltage converter during the redundancy operating mode. This can also save costs. The redundancy of the redundancy operating mode relates to a redundancy to the operating mode. Thus, the basic voltage converter forms a redundancy to the main voltage converter. The basic voltage converter can also be used to form a redundancy to a drive motor which is able to be supplied with alternating current by the main voltage converter.

In some implementations, the basic voltage converter is designed to convert, in a feed-in mode, a direct current of the power storage unit and/or a direct current of the fuel cell and/or a current of the generator into an alternating current for feeding current into a power grid. As a result, the so-called vehicle-to-grid can be implemented, by way of which the power grid can be stabilized. The power grid is the power grid from which the power storage unit can be charged. The power grid can thus act as a power source and/or a current sink. In some examples, the feed-in mode is delayed, that is to say does not take place at the same time as the redundancy operating mode or the operating mode.

In some examples, the electrical circuit includes electrical switches which are able to be used to switch current flows through the electrical circuit in accordance with the various modes. In some examples, semiconductors or relays or contactors are conceivable as switches. This provides a particularly practical solution.

In some examples, the electrical circuit is designed in such a way that the electrical circuit is operated or able to be operated simultaneously in the operating mode and in the redundancy operating mode, and/or the redundancy operating mode is operated or able to be operated if the main voltage converter or the electric drive motor able to be supplied with alternating current by the main voltage converter has a fault. If the electrical circuit is operated simultaneously in the operating mode and in the redundancy operating mode, it is an auxiliary operating mode which is realized by way of the basic voltage converter, since an auxiliary drive is able to be supplied with alternating current by way of the basic voltage converter in this way. If the electrical circuit is operated in the redundancy operating mode when the main voltage converter has a fault, the basic voltage converter serves as redundancy for the main voltage converter. If the electrical circuit is operated in the redundancy operating mode when the drive motor able to be supplied with alternating current by the main voltage converter has a fault, the basic voltage converter allows redundant drive, such as when an electric drive motor different than with the main voltage converter is operated or able to be operated by the basic voltage converter.

In some implementations, a DC-DC voltage converter is connected between the basic voltage converter and the power storage unit to convert the current converted by the basic voltage converter in the charging mode, that is to say current converted from alternating current into direct current, to a DC voltage level for charging the power storage unit, and in that the electrical circuit is designed in such a way that the DC-DC voltage converter is bypassed in the redundancy operating mode and/or in the feed-in mode. This increases the efficiency in these modes. The DC-DC voltage converter is capable of converting a DC voltage (of a first level) into a DC voltage of another level and may, for instance, be in the form of a step-up or step-down converter.

In some examples, the electrical circuit is electrically coupled to a power storage unit and/or an electric drive motor and/or a further electric drive motor. In other words, the electrical circuit is provided with a power storage unit or with an electric drive motor or with a power storage unit and an electric drive motor or with a power storage unit, an electric drive motor and a further electric drive motor or with an electric drive motor and a further electric drive motor, where the electrical circuit is electrically coupled to the provided devices. In this case, the power storage unit is electrically coupled to the basic voltage converter and/or the main voltage converter. By coupling the basic voltage converter to the power storage unit, the power storage unit is chargeable. On the other hand, power is thus able to be fed from the power storage unit into a or into the power grid. Furthermore, the electric drive motor is coupled to the main voltage converter and/or the basic voltage converter. As a result, the drive motor is able to be supplied with electrical energy, that is to say alternating current, for its drive by the voltage converter or voltage converters. Moreover, the further electric drive motor may be electrically coupled to the basic voltage converter. As a result, the further electric drive motor is able to be supplied with electrical energy, that is to say alternating current, for its drive. In some examples, the power storage unit and/or the drive motors are designed separately to the electrical circuit.

In some implementations, the electrical circuit, and everything comprised by it, is arranged in a housing. For example, the housing and/or the electrical circuit have connections for the electrical coupling of the electrical circuit to the power grid and/or the power storage unit and/or the electric drive motor and/or the further electric drive motor. The electrical circuit has in each case a connection for electrically coupling or connecting the electrical circuit to the power storage unit, such as the basic voltage converter to the power storage unit, and/or the power grid, such as the basic voltage converter to the power grid, and/or the electric drive motor, such as the main voltage converter to the electric drive motor, and/or the further electric drive motor, such as the basic voltage converter to the further electric drive motor. In some examples, the housing is designed to be electrically insulating. Furthermore, the power grid and/or the power storage unit and/or the electric drive motor and/or the further electric drive motor may be arranged outside the housing. In addition, the electrical circuit or the housing in which the electrical circuit is located may form a module. The housing comprises passive or active cooling for the electrical circuit.

In some examples, the electrical circuit is a high-voltage circuit and/or a distribution circuit. It is a so-called battery junction box, a battery disconnect unit or power distribution unit. In other words, the electrical circuit includes switching devices by way of which the power storage unit, one of the voltage converters or the voltage converters and/or one of the drive motors or the drive motor are able to be electrically coupled to and/or decoupled from each other.

In some implementations, the electrical circuit is electrically coupled to a power grid. In other words, the electrical circuit is provided with a power grid, where the power grid is formed separately from the electrical circuit and is stationary, where the electrical circuit is designed to be movable in relation to the power grid, as part of a vehicle.

In some examples, the further drive motor is a redundant drive motor and/or in that the drive motor is a main drive motor and/or in that the further electric drive motor is an auxiliary-drive drive motor and/or in that the further electric drive motor is a redundancy drive motor for the main drive motor. For example, the auxiliary drive motor or the redundancy motor is able to drive an axle which differs from the axle which is able to be driven by the main drive. Alternatively, the auxiliary drive motor or the redundancy motor is able to drive the same axle as the main drive.

In some implementations, in a recuperation mode of the auxiliary drive, which is able to be used as a generator, electrical energy is able to be transferred to the power storage unit via the basic voltage converter. This allows the power storage unit to be electrically charged. This is effective when braking a vehicle, as it spares a service brake.

In some examples, in the operating mode, the drive motor is supplied or able to be supplied with alternating current by the main voltage converter and/or in that, in the redundancy operating mode, the further drive motor is supplied or able to be supplied with alternating current by the basic voltage converter and/or in that the drive motor is supplied or able to be supplied with alternating current both by the main voltage converter and by the basic voltage converter. If the drive motor is able to be supplied with alternating current both by the main voltage converter and by the basic voltage converter, it is conceivable for the same excitation winding of the drive motor to be supplied with alternating current both by the main voltage converter and by the basic voltage converter, in order in particular to drive the drive motor. Alternatively to this, it is conceivable for the drive motor to have a main excitation winding, which is able to be supplied with alternating current by the main voltage converter, and a redundancy excitation winding, which is able to be supplied with alternating current by the basic voltage converter. This alternative is used if the main voltage converter or the main excitation winding is faulty.

Another aspect of the disclosure provides an on-board power supply system. The on-board power supply system includes the electrical circuit. This solution has the same advantages as the electrical circuit. The on-board power supply system is designed for a vehicle and has different voltage levels, for example 5 volts, 12 volts, 24 volts, 48 volts, 400 volts, 600 volts and/or 800 volts nominal voltage.

Yet another aspect of the disclosure provides a vehicle which provides the same advantages as the electrical circuit. The vehicle includes the electrical circuit or the on-board power supply system. The vehicle is an electric vehicle or a hybrid vehicle. The vehicle may be a passenger car or a truck.

The vehicle includes the fuel cell and/or the power storage unit, such as one of the examples of the power storage unit, and/or the generator, such as one of the examples of the generator, and/or the range extender and/or the combustion engine. In addition, the vehicle may include the electric drive motor or the electric drive motors.

Another aspect of the disclosure provides a method having the same advantages as the electrical circuit. The method for operating the electrical circuit, the on-board power supply system or the vehicle includes the generation of data which are characteristic of operating the redundancy operating mode in parallel with the operating mode, or of data which are characteristic of operation in the redundancy operating mode if data which are characteristic of a fault in the main voltage converter or in the drive motor able to be supplied with alternating current by the main voltage converter are received. The method is a computer-implemented method which is able to be carried out on a control device which is arranged outside or inside the electrical circuit. The data are computer-readable and are available digitally. The data are made available to the method by sensors or further control devices.

Another aspect of the disclosure provides a computer program having the same advantages as the electrical circuit. The computer program includes commands which, when executed by a computer, cause the latter to carry out the steps of the method. Instead of a computer, a control device may also be used for this purpose.

Yet another aspect of the disclosure provides a computer-readable medium having the same advantages as the electrical circuit. The computer-readable medium includes the computer program. The computer-readable medium is a non-volatile memory which is integrated into the control device.

The features disclosed in connection with the electrical circuit may be transferred to each of the on-board power supply system, the vehicle, the method, the computer program and the computer-readable medium, and vice versa in each case.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an exemplary vehicle.

Like reference symbols in the various drawings indicate like elements.

### DETAILED DESCRIPTION

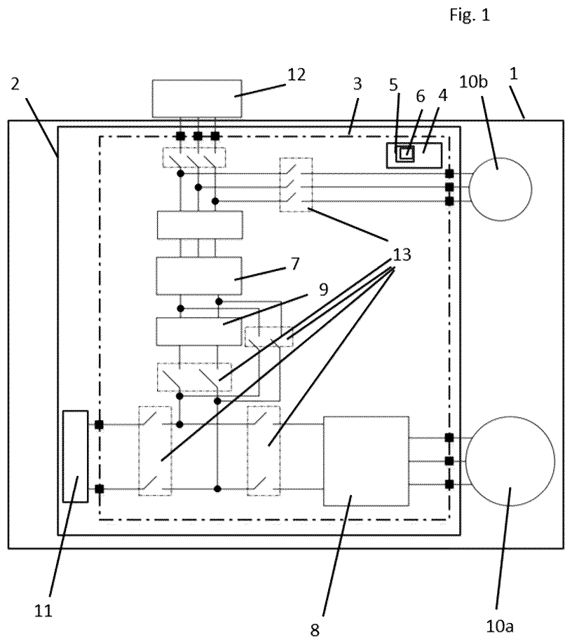

FIG. 1 shows an exemplary vehicle 1, which includes an on-board power supply system 2 and an electrical circuit 3. Moreover, the electrical circuit 3 includes a control device 4. The control device 4 includes a computer-readable medium 5 on which a computer program 6 is stored. The electrical circuit 3 includes a basic voltage converter 7, a main voltage converter 8, a DC-DC voltage converter and electrical switches 13. The electrical circuit 3 and thus also the on-board power supply system 2 are electrically connected to an external, stationary power grid 12, a power storage unit 11, an electric drive 10a, which serves as the main drive of the vehicle 1, and a further electric drive 10b, which serves as a redundancy drive motor for the vehicle 1. The electrical switches 13 are used to switch current flows through the electrical circuit 3 in accordance with various modes. The electrical circuit 3 and thus the basic voltage converter 7 and the main voltage converter 8 are able to be switched between the various modes. The various modes are the following: charging mode, operating mode, redundancy operating mode, feed-in mode and recuperation mode. In the charging mode, alternating current from the power grid 12 is converted by way of the basic voltage converter into a direct current for a power storage unit 11, whereby the power storage unit 11 is charged. A DC-DC voltage converter 9 is connected between the basic voltage converter 7 and the power storage unit 11 to convert the current converted in the charging mode by the basic voltage converter 7 to a DC voltage level for charging the power storage unit 11. In the redundancy operating mode, a direct current of the power storage unit 11 is converted into an alternating current for supplying power to the further electric drive motor 10b. In the operating mode, a direct current of the power storage unit 11 is converted by way of the main voltage converter 8 into an alternating current for supplying power to the electric drive motor 10a. In the feed-in mode, a direct current of the power storage unit 11 is converted by way of the basic voltage converter into an alternating current for feeding current into the power grid 12. The DC-DC voltage converter 9 is bypassed here by an electrical switch 13. The redundancy operating mode is initialized if a fault in the main voltage converter 8 and/or in the electric drive motor 10a is identified, thus creating a redundant drive for the vehicle 1. The charging mode is initialized if the power storage unit 11 must or is intended to be charged. In the recuperation mode, electrical energy is transferred via the basic voltage converter 7 to the power storage unit 11 by virtue of the further electric drive motor 10b being used as a generator in the braking mode, and the power storage unit 11 is thus charged. The operating mode is active as long as no fault in the main voltage converter 8 or in the electric drive motor 10a is identified. These faults are identified by sensors. The modes are then changed by the control device 4. In some examples, the electric drive motors 10a, 10b are permanently excited synchronous machines. The power storage unit 11 is a rechargeable traction battery having a nominal voltage of at least 600 volts. The vehicle may be a passenger car which is in the form of an electric vehicle. The electrical circuit 3 is located in a housing and forms a module, as a result of which the electrical circuit 3 is able to be used in a versatile manner.

A number of implementations have been described. Nevertheless, it will be understood that various modifications may be made without departing from the spirit and scope of the disclosure. Accordingly, other implementations are within the scope of the following claims.

What is claimed is:

1. An electrical circuit for a vehicle, the electric circuit comprising:
a basic voltage converter converting, in a charging mode, an alternating current from a power grid into a direct current for a power storage unit,
wherein during a redundancy operating mode, the basic voltage converter converts a direct current of the power storage unit and/or a direct current of a fuel cell and/or a current of a generator into an alternating current for supplying power to an electric drive motor.

2. The electrical circuit of claim 1, further comprising:
a main voltage converter designed to convert, in an operating mode, a direct current of the power storage unit and/or a direct current of the fuel cell and/or a current of the generator into an alternating current for supplying power to the electric drive motor.

3. The electrical circuit of claim 1, wherein the basic voltage converter converts, in a feed-in mode, a direct current of the power storage unit and/or a direct current of the fuel cell and/or a current of the generator into an alternating current for feeding current into a power grid.

4. The electrical circuit of claim 1, further comprising electrical switches used to switch current flows through the electrical circuit in accordance with various modes.

5. The electrical circuit of claim 4, wherein the electrical circuit is designed to operate simultaneously in the operating mode and in the redundancy operating mode, and/or the redundancy operating mode is operated if the main voltage converter or the electric drive motor able to be supplied with alternating current by the main voltage converter has a fault.

6. The electrical circuit of claim 1, further comprising a DC-DC voltage converter connected between the basic voltage converter and the power storage unit to convert the current converted by the basic voltage converter in the charging mode to a DC voltage level for charging the power storage unit,
wherein the DC-DC voltage converter is bypassed in the redundancy operating mode and/or in the feed-in mode.

7. The electrical circuit of claim 1, wherein the electrical circuit is electrically coupled to a power grid.

8. The electrical circuit of claim 1, wherein the electrical circuit is electrically coupled to a power storage unit and/or an electric drive motor and/or a further electric drive motor.

9. The electrical circuit of claim 8, wherein the further drive motor is a redundant drive motor and/or in that the drive motor is a main drive motor and/or in that the further electric drive motor is an auxiliary-drive drive motor and/or in that the further electric drive motor is a redundancy drive motor for the main drive motor.

10. The electrical circuit of claim 8, wherein the drive motor is supplied with alternating current by the main voltage converter and/or in that the further drive motor is supplied with alternating current by the basic voltage converter and/or in that the drive motor is supplied with alternating current both by the main voltage converter and by the basic voltage converter.

11. An on-board power supply system comprising an electrical circuit of claim 1.

12. A vehicle having the on-board power supply system of claim 11.

13. A method for operating an electrical circuit, the method comprising:
providing a basic voltage converter, wherein the basic voltage converter converts in a charging mode, an alternating current from a power grid into a direct current for a power storage unit, wherein during a redundancy operating mode, the basic voltage converter converts a direct current of the power storage unit and/or a direct current of a fuel cell and/or a current of a generator into an alternating current for supplying power to an electric drive motor; and
generating data which are characteristic of operating the redundancy operating mode in parallel with the operating mode, or of data which are characteristic of operation in the redundancy operating mode if data which are characteristic of a fault in the main voltage converter or in the drive motor able to be supplied with alternating current by the main voltage converter are received.

14. A computer program comprising commands which, when executed by a computer, cause the latter to carry out the steps of the method of claim 13.

15. A computer-readable medium comprising the computer program of claim 14.
